(19) United States
(12) Patent Application Publication
(10) Pub. No.: US 2023/0304812 A1
(43) Pub. Date: Sep. 28, 2023

(54) NAP SPOT SELECTION METHOD AND NAP SPOT SELECTION SYSTEM

(71) Applicant: SUBARU CORPORATION, Tokyo (JP)

(72) Inventors: Isao TSUKUI, Tokyo (JP); Jun KIKUCHI, Tokyo (JP)

(73) Assignee: SUBARU CORPORATION, Tokyo (JP)

(21) Appl. No.: 18/122,193

(22) Filed: Mar. 16, 2023

(30) Foreign Application Priority Data
Mar. 25, 2022 (JP) 2022-050284

(51) Int. Cl. G01C 21/34; G01C 21/36

(52) U.S. Cl. CPC G01C 21/3469; G01C 21/3476; G01C 21/3691

(57) ABSTRACT

A nap spot selection method includes: choosing a plurality of nap spots positioned along a traveling route of an electric vehicle that includes a battery and an air conditioner; acquiring data on an outside air temperature of each of the chosen nap spots; calculating, based on the outside air temperature data, a power consumption amount of the battery where the air conditioner is operated for a predetermined time at each of the nap spots; calculating, based on the outside air temperature data, a deterioration level of the battery at each of the nap spots; and selecting, from the plurality of nap spots, a nap spot in which the power consumption amount of the battery and/or the deterioration level of the battery are/is relatively low, based on the calculated power consumption amount of the battery and the calculated deterioration level of the battery.

### CROSS-REFERENCE TO RELATED APPLICATION

The present application claims priority from Japanese Patent Application No. 2022-050284 filed on Mar. 25, 2022, the entire contents of which are hereby incorporated by reference.

### BACKGROUND

The disclosure relates to a nap spot selection method and a nap spot selection system that select a nap spot positioned along a traveling route of a vehicle.

In long-distance driving on a freeway, a user may sometimes take a break by stopping a vehicle for a long time, such as taking a nap or spending a night in the vehicle at a rest area or a parking area. The user may sometimes use an air conditioner during a long time stop of the vehicle to ensure a comfort in a vehicle compartment.

An electric vehicle such as an electric automobile or a hybrid vehicle is equipped with a battery directed to traveling of the vehicle. Unlike an engine vehicle, the electric vehicle has no noise or exhaust gas caused by idling. Accordingly, the user is able to take a nap comfortably upon using the air conditioner during a stop of the vehicle. However, operating the air conditioner for a long time results in an increase in an amount of power consumption of the battery.

In order to suppress the power consumption amount of the battery as a result of operating the air conditioner during a stop of the vehicle, Japanese Unexamined Patent Application Publication (JP-A) No. 2019-22377 discloses a vehicle system that displays, on an in-vehicle display, information on a facility having an external power supply device when an operation of an air conditioner is predicted during a long time stop of an electric vehicle. The vehicle system predicts the operation of the air conditioner during the stop of the vehicle on the basis of data on an outside air temperature. In a case where the operation of the air conditioner is predicted, the vehicle system displays the information on the facility having the external power supply device that allows for charging of the battery, by giving more priority to the information on the facility having the external power supply device than information on any other facility among a plurality of facilities.

### SUMMARY

An aspect of the disclosure provides a nap spot selection method including: choosing nap spots positioned along a traveling route of an electric vehicle that includes a battery and an air conditioner; acquiring data on an outside air temperature of each of the chosen nap spots; calculating, based on the outside air temperature data, a power consumption amount of the battery when the air conditioner is operated for a predetermined time at each of the nap spots; calculating, based on the outside air temperature data, a deterioration level of the battery at each of the nap spots; and selecting, from the nap spots, a nap spot in which the power consumption amount of the battery and/or the deterioration level of the battery are/is relatively low, based on the calculated power consumption amount of the battery and the calculated deterioration level of the battery.

An aspect of the disclosure provides a nap spot selection system that includes a communicator and a control unit. The communicator is configured to acquire data on an outside air temperature from outside of an electric vehicle that includes a battery and an air conditioner. The control unit is coupled to the air conditioner and the communicator, and includes a choosing unit, a first calculating unit, a second calculating unit, and a selecting unit. The choosing unit is configured to choose nap spots positioned along a traveling route of the electric vehicle. The first calculating unit is configured to calculate, based on the outside air temperature data acquired by the communicator, a power consumption amount of the battery when the air conditioner is operated for a predetermined time at each of the nap spots. The second calculating unit is configured to calculate, based on the outside air temperature data, a deterioration level of the battery at each of the nap spots. The selecting unit is configured to select, from the nap spots, a nap spot in which the power consumption amount of the battery and/or the deterioration level of the battery are/is relatively low, based on the power consumption amount of the battery calculated by the first calculating unit and the deterioration level of the battery calculated by the second calculating unit.

An aspect of the disclosure provides a nap spot selection system that includes a communicator and circuitry. The communicator is configured to acquire data on an outside air temperature from outside of an electric vehicle that includes a battery and an air conditioner. The circuitry is coupled to the air conditioner and the communicator, and configured to: choose nap spots positioned along a traveling route of the electric vehicle; calculate, based on the outside air temperature data acquired by the communicator, a power consumption amount of the battery when the air conditioner is operated for a predetermined time at each of the nap spots; calculate, based on the outside air temperature data, a deterioration level of the battery at each of the nap spots; and select, from the nap spots, a nap spot in which the power consumption amount of the battery and/or the deterioration level of the battery are/is relatively low, based on the calculated power consumption amount of the battery and the calculated deterioration level of the battery.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram schematically illustrating an example of a configuration of a nap spot selection system according to one example embodiment of the disclosure.

FIG. 2 is a diagram illustrating an example of patterns of a traveling route having different nap spots from each other.

FIG. 3 is a map illustrating an example of a relationship between a temperature and a state of charge used for calculating a battery deterioration amount.

FIG. 4 is a map illustrating an example of a power consumption amount and the battery deterioration amount for each of patterns having different nap spots from each other for the traveling route.

FIG. 5 is a diagram illustrating an example of a quadrant created on the basis of a pattern A₂, a pattern B₂, a pattern C₂, and a pattern D₂.

FIG. 6A is a flowchart illustrating an example of a method of selecting a nap spot.

FIG. 6B is a flowchart illustrating an example of the method of selecting the nap spot.

FIG. 7 is a diagram illustrating an example of a quadrant created on the basis of a pattern A₃, a pattern B₃, a pattern C₃, and a pattern D₃.

### DETAILED DESCRIPTION

An amount of power consumption of a battery resulting from an operation of an air conditioner during a stop of a vehicle varies depending on a surrounding environment, such as an outside air temperature of a nap spot at which the vehicle is stopped. Accordingly, the battery can deteriorate due to the necessity of more electric power than expected or due to an output of the electric power for a long time in a severe environment, depending on which spot on a driving route the nap spot is to be set.

It is desirable to provide a nap spot selection method and a nap spot selection system that make it possible to suppress a power consumption amount and/or a deterioration amount of a battery directed to traveling of a vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

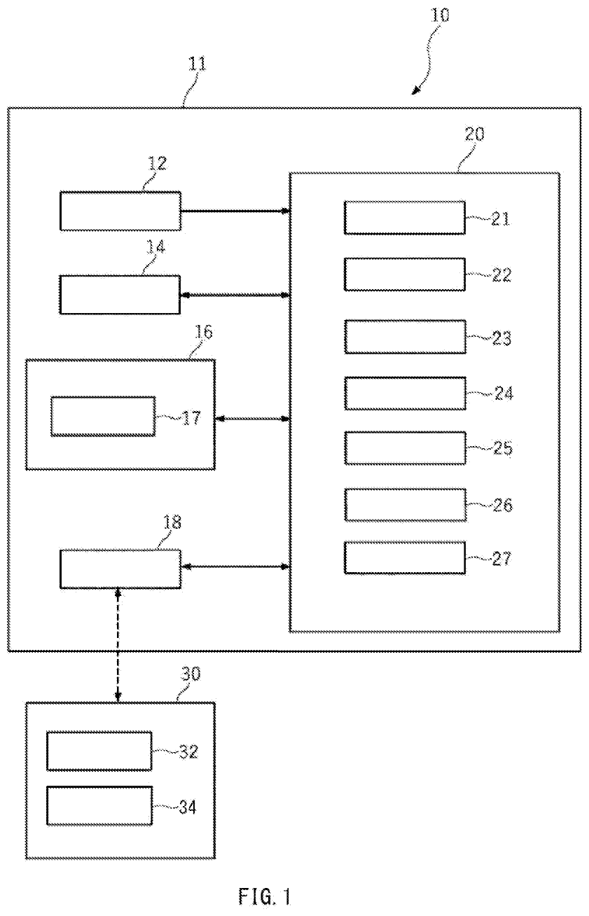

FIG. 1 is a diagram schematically illustrating an example of a configuration of a nap spot selection system 10 according to an example embodiment of the disclosure. The nap spot selection system 10 may be applied to a vehicle 11 provided with a secondary battery 12 (hereinafter, also simply referred to as a “battery 12”) as a drive source directed to traveling of the vehicle 11. For example, the nap spot selection system 10 may be applied to an electric vehicle such as an electric automobile, a hybrid vehicle, or a plug-in hybrid vehicle. In the example embodiment, the vehicle 11 on which the nap spot selection system 10 is to be mounted may be an electric vehicle that does not include a drive engine.

The nap spot selection system 10 may be a system that chooses a spot (a nap spot) at which the vehicle 11 is to be stopped for a long time to take a break in a vehicle compartment, such as a spot at which a nap is to be taken during a traveling route from a departure point to a destination when a user drives for a long distance from the departure point to the aimed destination. The nap spot may be chosen from any of a plurality of nap spots positioned at different locations at which a power consumption amount and/or a deterioration level of the battery 12 are/is estimated to be low when an air conditioner 14 is operated for a predetermined time. Hereinafter, a configuration of the nap spot selection system 10 will be described in detail.

Referring to FIG. 1, the nap spot selection system 10 according to the example embodiment may include: the battery 12 directed to traveling of the vehicle 11 and mounted on the vehicle 11; the air conditioner 14; a display 16; an input device 17 that allows for input of information; a communicator 18 configured to communicate with a server 30 provided outside of the vehicle 11; and a control unit 20. The control unit 20 may include a storage 21, a choosing unit 22, a battery remaining amount calculating unit 23, a power consumption amount calculating unit 24, a battery deterioration level calculating unit 25, a quadrant creating unit 26, and a selecting unit 27. In one embodiment, the power consumption amount calculating unit 24 may serve as a “first calculating unit”. In one embodiment, the battery deterioration level calculating unit 25 may serve as a “second calculating unit”.

The battery 12 may be, for example, a lithium-ion secondary battery having a rated voltage of 200 V or 250 V without limitation. The battery 12 may be coupled to an unillustrated charging unit. The battery 12 may be chargeable by coupling the battery 12 to an external power supply device via the charging unit at a charging station or any other charging spot.

The air conditioner 14 may perform air conditioning inside a vehicle compartment, and configured to operate by receiving a supply of electric power from the battery 12.

The communicator 18 may be, for example, a data communication module (DCM), and configured to communicate with an information processing device provided outside of the vehicle 11. In the example embodiment, the communicator 18 may be configured to communicate with the server 30 as the information processing device provided at an information processing center positioned outside of the vehicle 11.

The server 30 may include a receiver 32 that receives information and a transmitter 34 that transmits data to the outside. The server 30 may transmit, from the transmitter 34 to the vehicle 11, data on an outside air temperature and/or weather received from a weather satellite, for example. The nap spot selection system 10 may supply, to the control unit 20, data received from the server 30 via the communicator 18. The nap spot selection system 10 may also acquire, via the communicator 18, map data stored on the server 30, for example. The thus-acquired map data may be held in the storage 21 of the control unit 20 or displayed on the display 16.

The display 16 may be provided in front of a driver's seat inside the vehicle compartment, and display information on the vehicle 11 or any other information. In the example embodiment, the display 16 may have a touch panel overlaid on a display screen of the display 16. The touch panel may be the input device 17 configured to allow input of information. A user may be able to input a departure point and a destination of the vehicle 11 through the input device 17. For example, the map data acquired by the control unit 20 may be displayed on the display 16, and the departure point and the destination may be inputted through the input device 17 or addresses of the departure point and the destination may be inputted through the input device 17 to set the departure point and the destination.

The control unit 20 may control devices mounted on the vehicle 11, including the nap spot selection system 10. The control unit 20 may include: an information processor such as a central processing unit (CPU) or an application specific integrated circuit (ASIC); a storage such as a random-access memory (RAM) or a read-only memory (ROM); and an input/output interface, for example. The control unit 20 may be electrically coupled to the battery 12, the air conditioner 14, the display 16, the input device 17, and the communicator 18.

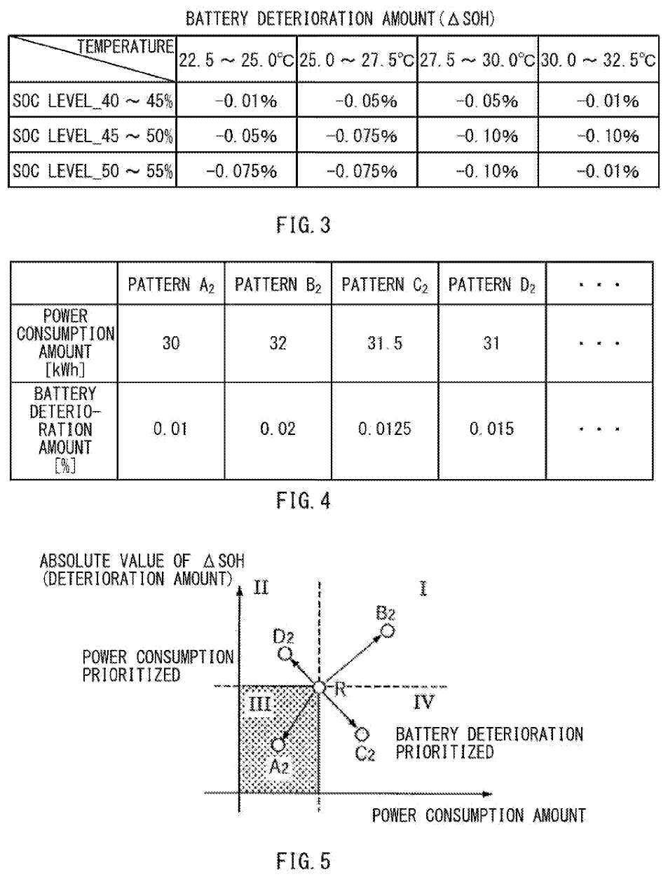

The storage 21 of the control unit 21 may contain, for example, a program that controls each device coupled to the control unit 20. The storage 21 may contain data on a map illustrated by way of example in FIG. 3. The map may be used by the battery deterioration level calculating unit 25 to calculate a deterioration amount of the battery 12 and indicate a relationship between a temperature and a state of charge (SOC) of the battery 12.

The choosing unit 22 may choose a plurality of nap spots positioned along a traveling route from the departure point to the destination of the vehicle 11 inputted via the input device 17. In the nap spot selection system 10 according to the example embodiment, the choosing unit 22 may choose, as the nap spot, a rest area and a parking area positioned on a freeway in a case where the traveling route includes the freeway.

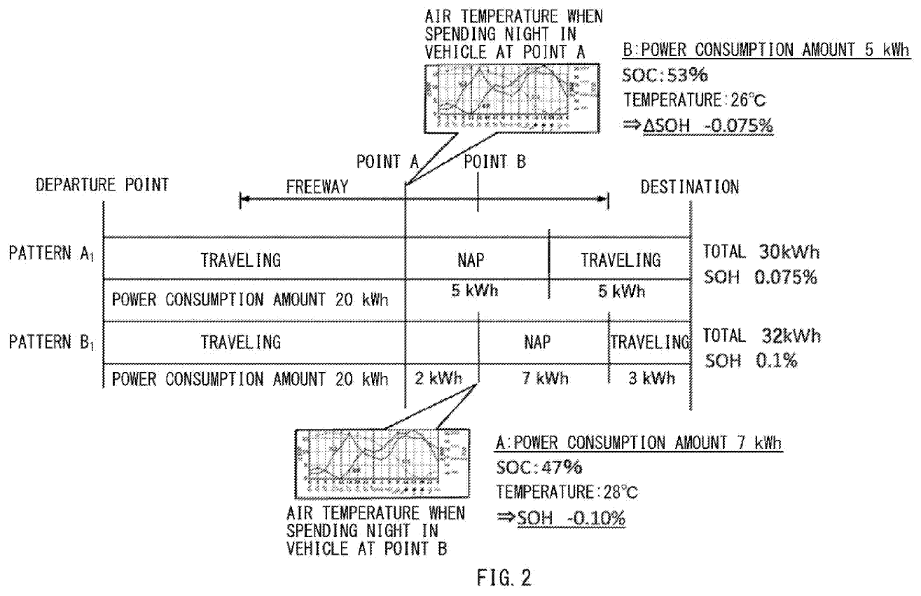

FIG. 2 is a diagram illustrating an example of patterns of a traveling route having different nap spots from each other. In an example case where a traveling route that includes a freeway has a point A and a point B as the rest area or the parking area on the freeway, the choosing unit 22 may choose the point A and the point B as the nap spots. Optionally, a type of the nap spot may be set by the user through the input device 17. The point A is positioned closer to the departure point than the point B in an example illustrated in FIG. 2. The choosing unit 22 may choose, as a pattern A₁ and a pattern B₁ to take a nap on a traveling route, two patterns including: the pattern A₁ that goes to the destination after taking a nap at the point A from the departure point; and the pattern B₁ that goes to the destination after passing through the point A and taking a nap at the point B. In some embodiments, the choosing unit 22 may choose two or more patterns to take a nap, on the basis of the number of nap spots.

The battery remaining amount calculating unit 23 may calculate a state of charge (SOC) of the battery 12. The SOC may be calculated on the basis of an output of a battery sensor. The battery 12 may be provided with the battery sensor.

The power consumption amount calculating unit 24 may calculate a power consumption amount of the battery 12. In the example embodiment, the power consumption amount calculating unit 24 may calculate, on the basis of the outside air temperature data acquired via the communicator 18, the power consumption amount of the battery 12 where the air conditioner 14 is operated for a predetermined time at each of the nap spots chosen by the choosing unit 22. A condition for an operation of the air conditioner 14 at the nap spot, such as a temperature of air conditioning, may be set in advance by the user through the input device 17 upon setting the traveling route. A time during which the air conditioner 14 is to be operated, or a predetermined time, may be a time during which the vehicle 11 is to be stopped at the nap spot, and may be inputted by the user through the input device 17 upon setting the traveling route. In one embodiment, the time during which the air conditioner 14 is to be operated may serve as a “predetermined time”. For example, an air blowing mode where the predetermined time is 3 hours and the air conditioning temperature of the air conditioner 14 is 22 degrees centigrade may be set as a predetermined blowing mode suitable for taking a nap.

In an example illustrated in FIG. 2, for the pattern A₁, the outside air temperature data of the point A as the nap spot may be acquired, and the power consumption amount of the battery 12 that is based on the operation of the air conditioner 14 at the point A may be calculated on the basis of the outside air temperature data, the preset stop time of the vehicle 11 (the predetermined time), and the operation condition of the air conditioner 14. Similarly, for the pattern B₁, the outside air temperature data of the point B may be acquired, and the power consumption amount of the battery 12 that is based on the operation of the air conditioner 14 at the point B may be calculated on the basis of the outside air temperature data, the preset predetermined time, and the operation condition of the air conditioner 14. In an example of FIG. 2, the power consumption amount at the point A may be calculated as 5 kWh, and the power consumption amount at the point B may be calculated as 7 kWh.

The power consumption amount calculating unit 24 may also calculate a power consumption amount of the battery 12 that is based on the traveling of the vehicle 11 on the traveling route. For example, the power consumption amount calculating unit 24 may calculate the power consumption amounts of the battery 12 that are based on the traveling of the vehicle 11 on the traveling route before and after the nap spot, for each of the patterns of the traveling route. In an example illustrated in FIG. 2, for the pattern A₁, the power consumption amount that is based on the traveling of the vehicle 11 from the departure point to the point A may be calculated as 20 kWh, and the power consumption amount that is based on the traveling of the vehicle 11 from the point A to the destination may be calculated as 5 kWh. For the pattern B₁, the power consumption amount that is based on the traveling of the vehicle 11 from the departure point to the point B may be calculated as 22 kWh, and the power consumption amount that is based on the traveling of the vehicle 11 from the point B to the destination may be calculated as 3 kWh.

The battery deterioration level calculating unit 25 may calculate a deterioration level of the battery 12 at each of the nap spots, on the basis of the outside air temperature data of each of the nap spots. For example, the battery deterioration level calculating unit 25 may calculate the deterioration level of the battery 12, on the basis of a temperature of the battery 12 upon the operation of the air conditioner 14 estimated on the basis of the outside air temperature data and the SOC of the battery 12 of each of the nap spots. In the example embodiment, the battery deterioration level calculating unit 25 may calculate, as the deterioration level, an amount of change in a state of health (SOH) that indicates a deterioration state of the battery 12. For example, the battery deterioration level calculating unit 25 may calculate the SOC at each of the nap spots, by calculating the SOC of the battery 12 at the departure point by the battery remaining amount calculating unit 23 and by further calculating, on the basis of the SOC at the departure point, the SOC of the battery 12 in a case of traveling to the nap spot. In an example illustrated in FIG. 2, for the pattern A₁, the SOC may be calculated as 53% where the temperature of the battery 12 at the point A is 26 degrees centigrade, and the SOC may be calculated as 47% where the temperature of the battery 12 at the point B is 28 degrees centigrade for the pattern B₁.

The battery deterioration level calculating unit 25 may calculate a deterioration amount (ΔSOH) of the battery 12, on the basis of the outside air temperature data and the SOC at the nap spot, and on the basis of data on a map that is stored in the storage 21 and indicates a preset relationship between a temperature and the SOC. FIG. 3 illustrates an example of a map illustrating an example relationship between the temperature and the SOC of the battery 12. In an example illustrated in FIG. 2, for the pattern A₁, the deterioration amount (ASOH) of the battery 12 in a case of operating the air conditioner 14 for the predetermined time at the point A may be calculated as −0.075% from the map illustrated in FIG. 3, where the temperature of the battery 12 is 26 degrees centigrade and the SOC is 53%. For the pattern B₁, the deterioration amount (ΔSOH) of the battery 12 at the point B may be calculated as −0.10%, where the temperature of the battery 12 is 28 degrees centigrade and the SOC is 47%.

The quadrant creating unit 26 may create a four-quadrant matrix in which the power consumption amount and the deterioration level of the battery 12 at each of the nap spots are divided into four quadrants, on the basis of a high-low degree of the power consumption amount and a high-low degree of the battery deterioration level. In the example embodiment, the quadrant creating unit 26 may plot the power consumption amount and the deterioration level of each pattern respectively calculated by the power consumption amount calculating unit 24 and the battery deterioration level calculating unit 25 on a graph that indicates the power consumption amount and the battery deterioration amount, and divide the plotted graph into four quadrants on the basis of the high-low degree of the power consumption amount and the high-low degree of the battery deterioration level.

In the following, described with reference to FIGS. 4 and 5 is an example of a procedure of creating the four-quadrant matrix by the quadrant creating unit 26. FIG. 4 is a map illustrating an example of the power consumption amount and the battery deterioration amount for each of patterns having different nap spots from each other that are respectively calculated by the power consumption amount calculating unit 24 and the battery deterioration level calculating unit 25. It should be noted that, in an example illustrated in FIG. 4, a traveling route is different from that illustrated in an example of FIG. 2. FIG. 4 illustrates values of the power consumption amount and the deterioration amount of the battery 12 of four patterns having different nap spots from each other, including a pattern A₂, a pattern B₂, a pattern C₂, and a pattern D₂, for a single traveling route. In some embodiments, the number of patterns may be five or more. In the following description, described is an example having four patterns including the pattern A₂, the pattern B₂, the pattern C₂, and the pattern D₂ for easier understanding.

Referring to FIG. 5, the quadrant creating unit 26 may create a graph in which the power consumption amount and the battery deterioration amount serve as respective axis thereof. In FIG. 5, a horizontal axis indicates the power consumption amount, and a vertical axis indicates an absolute value of the deterioration amount ΔSOH. Thereafter, the quadrant creating unit 26 may plot, on the graph, the power consumption amount and the battery deterioration amount of the battery 12 of each of the patterns. FIG. 5 illustrates points respectively plotted for the pattern A₂, the pattern B₂, the pattern C₂, and the pattern D₂ as a point A₂, a point B₂, a point C₂, and a point D₂.

Thereafter, the quadrant creating unit 26 may calculate a reference point R in which the sum of distances to the respective points A₂, B₂, C₂, and D₂ becomes the minimum. In FIG. 5, the reference point R may be a point in which a value of “R_A₂+R_B₂+R_C₂+R_D₂” becomes the minimum, where R_A₂ is a distance from the point R to the point A₂. In a case where the reference point R is calculated, the quadrant creating unit 26 may create the graph in which the horizontal axis indicates the power consumption amount and the vertical axis indicates deterioration amount with the reference point R being a center point. The thus-created graph may serve as the four-quadrant matrix. In the four-quadrant matrix illustrated in FIG. 5, a top right part, a top left part, a bottom left part, and a bottom right part respectively serve as a first quadrant I, a second quadrant II, a third quadrant III, and a fourth quadrant IV, with the reference point R being the center. The first quadrant I may be a region in which the power consumption amount and the battery deterioration amount are large. The second quadrant II may be a region in which the power consumption amount is small and the battery deterioration amount is large. The third quadrant III may be a region in which the power consumption amount and the battery deterioration amount are small. The fourth quadrant IV may be a region in which the power consumption amount is large and the battery deterioration amount is small. In an example illustrated in FIG. 5, the point A₂ may be plotted in the third quadrant III, the point B₂ may be plotted in the first quadrant I, the point C₂ may be plotted in the fourth quadrant IV, and the point D₂ may be plotted in the second quadrant II.

The selecting unit 27 may select, from the chosen nap spots, a nap spot in which the power consumption amount and/or the deterioration level of the battery 12 are/is low, on the basis of the power consumption amount and the deterioration level respectively calculated by the power consumption amount calculating unit 24 and the battery deterioration level calculating unit 25. In the example embodiment, the selecting unit 27 may select a pattern of the traveling route having the nap spot in which the power consumption amount and/or the deterioration level are/is low.

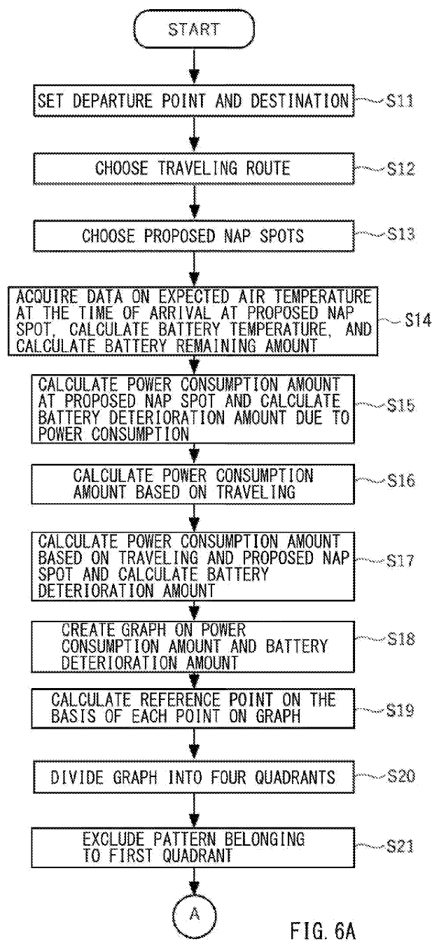

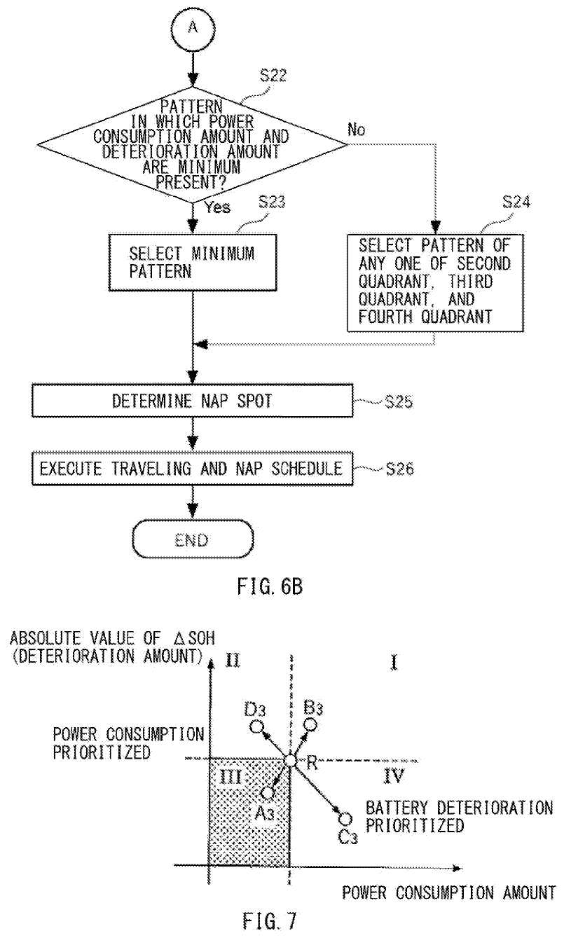

Described next with reference to FIGS. 6A and 6B is an example of a method of selecting a nap spot to be executed by the nap spot selection system 10.

In a case where the nap spot selection system 10 is started up and the departure point and the destination are inputted by the input device 17 (step S11), the control unit 20 may choose a traveling route that includes a freeway (step S12). One of the traveling routes may be chosen manually by the user or automatically by the control unit 20 in a case where multiple traveling routes are present. The choosing unit 22 may choose a plurality of nap spots positioned along the chosen traveling routes (step S13). For example, the choosing unit 22 may choose a plurality of proposed nap spots such as the rest area or the parking area. In one embodiment, this process may serve as a “choosing step”. Further, the choosing unit 22 may choose patterns of the traveling route having different nap spots from each other, on the basis of the plurality of chosen nap spots (step S13).

Thereafter, in step S14, in a case where the nap spots (the proposed nap spots) are chosen, the nap spot selection system 10 may acquire the outside air temperature data acquired via the communicator 18. In one embodiment, this process may serve as an “outside air temperature acquiring step”. Further, in step S14, the nap spot selection system 10 may calculate the temperature and the SOC of the battery 12 at each of the nap spots. In one embodiment, this process may serve as the “outside air temperature acquiring step”. The outside air temperature data may contain data on an expected air temperature at the time of arrival at the proposed nap spot.

Thereafter, in step S15, the power consumption amount calculating unit 24 may calculate the power consumption amount of the battery 12 where the air conditioner 14 is operated for the predetermined time at each of the nap spots. In one embodiment, this process may serve as a “power consumption amount calculating step”. Further, in step S15, the battery deterioration level calculating unit 25 may calculate the deterioration level of the battery 12. In one embodiment, this process may serve as a “battery deterioration level calculating step”. Thereafter, in step S16, the power consumption amount calculating unit 24 may calculate the power consumption amount of the battery 12 that is based on the traveling of the traveling route. In one embodiment, this process may serve as the “power consumption amount calculating step”. In some embodiments, the power consumption amount calculating step and the battery deterioration level calculating step may be reversed in order. For example, the power consumption amount of the battery 12 based on traveling of the vehicle 11 may be calculated prior to the calculation of the power consumption amount and/or the battery deterioration amount at the nap spot.

Thereafter, in step S17, the power consumption amount calculating unit 24 and the battery deterioration level calculating unit 25 may respectively calculate the power consumption amounts based on the operation of the air conditioner 14 at the nap spot and the traveling of the vehicle 11 and the battery deterioration amount, for each of the patterns having different nap spots from each other.

Thereafter, in a case where the power consumption amount and the battery deterioration amount of each of the patterns are calculated, the quadrant creating unit 26 may create a graph on the power consumption amount and the battery deterioration amount (step S18). Thereafter, the quadrant creating unit 26 may calculate the reference point R on the basis of the points of the respective patterns plotted on the graph (step S19). Thereafter, in a case where the reference point R is calculated, the quadrant creating unit 26 may divide the graph into four quadrants to create the four-quadrant matrix (step S20).

Thereafter, in step S21, the selecting unit 27 may exclude the pattern that belongs to the first quadrant I from the four-quadrant matrix. For example, the selecting unit 27 may exclude the pattern in which the power consumption amount and the battery deterioration amount become high from the four-quadrant matrix.

Thereafter, in step S22, the selecting unit 27 may determine whether the pattern in which both the power consumption amount and the battery deterioration level are the minimum is present among the remaining patterns. If the minimum pattern is present (step S22: Yes), the selecting unit 27 may select the minimum pattern (step S23). In an example illustrated in FIG. 5, the power consumption amount and the battery deterioration level of the point A₁ are low in value than those of other points B₂, C₂, and D₂ among the point A₂, the point B₂, the point C₂, and the point D₂. Accordingly, in a case where the point A₂ in which the power consumption amount and the battery deterioration level are the minimum is present in the third quadrant III, the selecting unit 27 may select the pattern A₂ that configures the point A₂. This helps to select the nap spot included in the chosen pattern A₂ as the nap spot that helps to suppress the power consumption amount and the deterioration amount of the battery 12.

In step S22, if the pattern in which the power consumption amount and the battery deterioration level are the minimum is not present (step S22: No), the selecting unit 27 may select, out of the four-quadrant matrix, the pattern belonging to the point of any one of the second quadrant II, the third quadrant III, and the fourth quadrant IV (step S24).

FIG. 7 is a diagram illustrating an example of a four-quadrant matrix created on the basis of a pattern A₃, a pattern B₃, a pattern C₃, and a pattern D₃ that have different nap spots from each other for a single traveling route, and illustrates an example of a selection method performed in step S24. Referring to FIG. 7, four points A₃, B₃, C₃, and D₃ respectively correspond to the four patterns A₃, B₃, C₃, and D₃. In an example illustrated in FIG. 7, the point D₃ in which the power consumption amount is the minimum may be positioned in the second quadrant II and the point C₃ in which the battery deterioration amount becomes the minimum may be positioned in the fourth quadrant IV, out of the four points A₃, B₃, C₃, and D₃. The point A₃ positioned in the third quadrant III may be a point in which both the power consumption amount and the battery deterioration level are suppressed in a balanced fashion. In such an example case, the selecting unit 27 may select the pattern belonging to the point of any one of the second quadrant II, the third quadrant III, and the fourth quadrant IV, on the basis of a preset priority order. For example, the pattern D₃ in which the power consumption amount becomes the minimum may be selected in a case where the suppression of the power consumption amount is to be prioritized, and the pattern C₃ in which the battery deterioration amount becomes the minimum may be selected in a case where the suppression of the battery deterioration level is to be prioritized. The pattern A₃ may be selected in a case where the balanced suppression of the power consumption amount and the battery deterioration level is to be prioritized. The priority order of selecting the pattern may be determined manually by the user via the input device 17, or may be determined automatically by the selecting unit 27 on the basis of a program on the preset priority order.

As an example of determining the priority order upon the selection of the pattern to be performed by the selecting unit 27, the suppression of the power consumption amount may be so set as to be prioritized in an example case where the SOC of the battery at the departure point is equal to or lower than a predetermined value. The suppression of the battery deterioration level may be so set as to be prioritized in an example case where the SOH of the battery 12 is equal to or less than a predetermined value. The balanced suppression of the power consumption amount and the battery deterioration level may be so set as to be prioritized in an example case where the SOC and the SOH of the battery 12 are higher than their respective predetermined values, or in an example case where the SOC and the SOH of the battery 12 are lower than their respective predetermined values.

Thereafter, in a case where one of the patterns is selected by the selecting unit 27 in step S23 or step S24, the nap spot of the set traveling route may be determined (step S25). Thereafter, the thus-determined traveling and nap schedule may be executed (step S26), which helps to suppress the power consumption amount and/or the deterioration level of the battery 12 from the departure point to the destination.

The nap spot selection system 10 and the nap spot selection according to the example embodiment described above help to propose the nap spot that helps to suppress the power consumption amount and/or the deterioration amount of the battery 12 for the set traveling route from the departure point to the destination. In some embodiments, the quadrant creating unit 26 may create the four-quadrant matrix on the basis of the high-low degree of the power consumption amount and the high-low degree of the deterioration level of the battery 12, which helps to efficiently select, from the points plotted on the four-quadrant matrix, the nap spot that helps to suppress the power consumption amount and/or the deterioration level.

The nap spot selection system 10 according to any embodiment of the disclosure may be applied to a hybrid vehicle that includes a traveling engine in addition to the battery 12 directed to the vehicle traveling. In such an example embodiment, the calculation of the power consumption amount of the battery 12 that is based on the traveling of the vehicle 11 (step S16) may be eliminated for the power consumption amount of the battery 12.

In the example embodiment described above, a rest area and a parking area positioned on a freeway may be chosen as the nap spot in a case where the traveling route includes the freeway. In some embodiments, the traveling route may not include the freeway. In such an example embodiment, the choosing unit 22 may choose, as the nap spot, a location or a facility on a traveling route at which a long time stop of the vehicle 11 is available, or the user may select a plurality of nap spots on a traveling route and input the selected nap spots through the input device 17.

In some embodiments, the nap spot selection system 10 may choose a pattern that includes two or more nap spots for a traveling route. In such an example embodiment, the number of spots at which a nap is to be taken (the number of nap spots) for a single traveling route may be set through the input device 17, or a distance to the next nap spot or an interval of time required for the next nap spot may be set in advance through the input device 17.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The control unit 20 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 20. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 20 illustrated in FIG. 1.

1. A nap spot selection method comprising:
choosing nap spots positioned along a traveling route of an electric vehicle, the electric vehicle including a battery and an air conditioner;
acquiring data on an outside air temperature of each of the chosen nap spots;
calculating, based on the outside air temperature data, a power consumption amount of the battery when the air conditioner is operated for a predetermined time at each of the nap spots;
calculating, based on the outside air temperature data, a deterioration level of the battery at each of the nap spots; and
selecting, from the nap spots, a nap spot in which the power consumption amount of the battery and/or the deterioration level of the battery are/is relatively low, based on the calculated power consumption amount of the battery and the calculated deterioration level of the battery.

2. The nap spot selection method according to claim 1, wherein the calculating the power consumption amount comprises calculating a power consumption amount of the battery that is based on traveling of the electric vehicle on the traveling route.

3. The nap spot selection method according to claim 1, further comprising:
plotting the calculated power consumption amount of the battery and the calculated deterioration level of the battery on a graph that indicates a power consumption amount and a battery deterioration amount; and
dividing the plotted graph into four quadrants, based on a high-low degree of the power consumption amount of the battery and a high-low degree of the deterioration level of the battery, wherein
the selecting the nap spot in which the power consumption amount of the battery and/or the deterioration level of the battery are/is relatively low comprises selecting, from the four quadrants, the nap spot positioned in one of the quadrants in which the power consumption amount of the battery and/or the deterioration level of the battery are/is relatively low.

4. The nap spot selection method according to claim 2, further comprising:
plotting the calculated power consumption amount of the battery and the calculated deterioration level of the battery on a graph that indicates a power consumption amount and a battery deterioration amount; and
dividing the plotted graph into four quadrants, based on a high-low degree of the power consumption amount of the battery and a high-low degree of the deterioration level of the battery, wherein
the selecting the nap spot in which the power consumption amount of the battery and/or the deterioration level of the battery are/is relatively low comprises selecting, from the four quadrants, the nap spot positioned in one of the quadrants in which the power consumption amount of the battery and/or the deterioration level of the battery are/is relatively low.

5. A nap spot selection system comprising:
a communicator configured to acquire data on an outside air temperature from outside of an electric vehicle, the electric vehicle including a battery and an air conditioner; and
a control unit coupled to the air conditioner and the communicator, and comprising
a choosing unit configured to choose nap spots positioned along a traveling route of the electric vehicle,
a first calculating unit configured to calculate, based on the outside air temperature data acquired by the communicator, a power consumption amount of the battery when the air conditioner is operated for a predetermined time at each of the nap spots,
a second calculating unit configured to calculate, based on the outside air temperature data, a deterioration level of the battery at each of the nap spots, and
a selecting unit configured to select, from the nap spots, a nap spot in which the power consumption amount of the battery and/or the deterioration level of the battery are/is relatively low, based on the power consumption amount of the battery calculated by the first calculating unit and the deterioration level of the battery calculated by the second calculating unit.

6. The nap spot selection system according to claim 5, wherein
the control unit further comprises a quadrant creating unit configured to:
plot the power consumption amount of the battery calculated by the first calculating unit and the deterioration level of the battery calculated by the second calculating unit on a graph that indicates a power consumption amount and a battery deterioration amount; and
divide the plotted graph into four quadrants, based on a high-low degree of the power consumption amount of the battery and a high-low degree of the deterioration level of the battery, and
the selecting unit is configured to select, from the four quadrants divided by the quadrant creating unit, the nap spot positioned in one of the quadrants in which the power consumption amount of the battery and/or the deterioration level of the battery are/is relatively low.

7. A nap spot selection system comprising:
a communicator configured to acquire data on an outside air temperature from outside of an electric vehicle that includes a battery and an air conditioner; and
circuitry coupled to the air conditioner and the communicator, and configured to:
choose nap spots positioned along a traveling route of the electric vehicle;
calculate, based on the outside air temperature data acquired by the communicator, a power consumption amount of the battery where the air conditioner is operated for a predetermined time at each of the nap spots;
calculate, based on the outside air temperature data, a deterioration level of the battery at each of the nap spots; and
select, from the nap spots, a nap spot in which the power consumption amount of the battery and/or the deterioration level of the battery are/is relatively low, based on the calculated power consumption amount of the battery and the calculated deterioration level of the battery.
